(19) United States
(12) Patent Application Publication
(10) Pub. No.: US 2025/0073727 A1
(43) Pub. Date: Mar. 6, 2025

(54) NOZZLE DEVICE

(71) Applicant: JetChill Ltd., Newcastle Upon Tyne (GB)

(72) Inventors: Colin MYERS, Newcastle Upon Tyne (GB); Lewis BETTS, Newcastle Upon Tyne (GB); Robert FLUNDER, Newcastle Upon Tyne (GB)

(73) Assignee: JetChill Ltd., Newcastle Upon Tyne (GB)

(21) Appl. No.: 18/824,252

(22) Filed: Sep. 4, 2024

(30) Foreign Application Priority Data
Sep. 4, 2023 (GB) 2313447.1

(51) Int. Cl. B05B 1/14

(52) U.S. Cl. CPC B05B 1/14

(57) ABSTRACT

A vapour dispensing device nozzle in which the nozzle comprises a plurality of apertures to create a plurality of bubbles when vapour is passed through the nozzle from a vapour producing source.

### FIELD OF THE INVENTION

This invention relates to a nozzle device for producing a vapour cloud and, preferably for creating vapour filled bubbles and, more particularly, to a nozzle that can be attached to a device for creating a vapour cloud to produce vapour filled bubbles.

### BACKGROUND TO THE INVENTION

Food and beverages are often served with garnish, and, in recent times, it has been possible to apply a vapour-filled bubble to consumable products, particularly beverages. The bubble is dispensed from a device that has a nozzle thereupon, the nozzle having an aperture therein to allow the vapour to be dispensed therethrough. The nozzle is often dipped into a bubble mixture and then the vapour is blown through the nozzle to fill a bubble as it is produced.

The application of a single bubble to the beverage creates an impressive and attractive garnish to the beverage. The vapour-filled bubble is applied to the surface of the beverage, most often using a device that heats a substance to create a cloud of vapour that is then blown into a food-safe bubble. The vapour that is within the bubble may contain a scent that can be used to enhance the flavour of the beverage. Once the surface of the bubble of vapour is fractured, or popped, the vapour is released. This usually occurs just before the user consumes the beverage. Once the bubble is fractured and the vapour is released, it is often inhaled during consumption of the beverage, which, where the vapour is scented, can enhance the flavour of the beverage. Additionally, the bubble provides an impressive aesthetic to beverages.

The bubble can also be placed on top of food, for example, over the top of a glass or bowl that contains food therein. Again, the fracture of the bubble releases a vapour that can contain an aroma to compliment or enhance the flavour of the food.

### SUMMARY OF THE INVENTION

Accordingly, the present invention is directed to a vapour dispensing device nozzle, the nozzle comprising a plurality of apertures. These apertures can, in one arrangement, be used to create a plurality of bubbles when vapour is passed through the nozzle.

Thus, the present invention is a nozzle for a device that can dispense a vapour-filled bubble. Unlike existing nozzles, the nozzle of the present invention is provided with a plurality of apertures therein. As a result, when the nozzle is used to create a bubble, a plurality of bubbles is created, rather than a single bubble. This is particularly useful in a bar or restaurant when the turbulent airflow can fracture a single bubble earlier than intended, thereby reducing the impact of the garnish. Additionally, the release of vapour can be more gradual be popping the bubbles over time, rather than having a single bubble that releases all of the vapour at once. Additionally, there may be circumstances where the vapour is of such a density that a single bubble will be too heavy of the bubble surface is too weak to contain the vapour, in which case a plurality of bubbles allows the vapour to be more easily held when dispensed into the bubble mixture. Additionally, or alternatively, the plurality of apertures can slow the speed of vapour passing therethrough, which can create a denser vapour cloud.

Advantageously, the nozzle comprises a neck portion and a face portion, with the neck portion having a smaller axial cross-sectional area than the face portion. Where the neck portion has a first cross-section for the flow of gas, and the nozzle face has a second, larger cross-section for the flow of gas, the pressure and speed of the gas can be controlled to allow a good flow of gas, without it being too strong. This reduces the risk of bursting the bubble prematurely. Additionally, where the surface area of the face of the nozzle is larger than the neck, there is more space for the plurality of apertures to be arranged on the face of the nozzle. The cross-sectional area different between the neck and the face may be created by providing the respective parts with different diameters.

It is preferable that the plurality of apertures is in the form of a layer of apertures positioned in the face portion of the nozzle, and more preferable that a second layer of apertures is arranged adjacent the first layer of apertures, with and the apertures in the first layer being offset from the apertures in the second layer. By having two layers of apertures that are arranged to be non-concentric, a large number of smaller bubbled can be formed. The bubbles may resemble frog spawn or a pile of caviar in their appearance, especially if the vapour therein is coloured.

One or more layers of apertures may be formed on one or more plates that may be fixed into the nozzle or they may be removable from the nozzle. As such, where the plates are removable, it will be appreciated that the aperture plate(s) can be replaced with further plates that may have different sized and/or shaped apertures therein. This allows a single nozzle to be adapted to a particular use according to the size and number of bubbles that are required. In one arrangement, the nozzle aperture plate(s) may have a single aperture therein. Where a single aperture is present in the plate, a corresponding plate may also be used with a single coaxial aperture. This allows for a single bubble to be created using the nozzle of the present invention. Thus, different sized vapour bubbles can be readily produced by swapping in different sized and/or shaped aperture plates.

In a particular arrangement, the apertures are honeycomb in shape. Honeycomb shaped, or hexagonal, shaped apertures provide an efficient use of space on the nozzle, by allowing the apertures to fit closely on the face of the nozzle, without creating a large amount of unusable space therein.

The nozzle may comprise rubber material and/or metallic material. The use of a rubber or plastics material reduces the risk of the bubble(s) being broken by a sharp edge as it is produced. The use of a metallic material allows for a more hard-wearing material, especially where parts are to be readily removed.

In one arrangement, the nozzle has the first part of a connection mechanism, so that the nozzle can be fitted to a vapour dispensing device, and the connection mechanism may comprise at least one magnetic portion to fit to a corresponding second part on a vapour dispensing device. Providing a connection mechanism allows the nozzle to be quickly and efficiently connected to a vapour dispensing device. Additionally, where magnets are employed to connect the nozzle to the device, a secure fixing is created that can allow for ready removable and replacement of the nozzle. Furthermore, the connection mechanism can allow for easy cleaning of the device. It will be appreciated that various connection mechanisms may be used, for example, the connection mechanism may comprise a clip or part of a bayonet fitting, the clip or bayonet fitting adapted to fit to a corresponding second part on a vapour dispensing device. Such fixings may also be provided with magnets. The fixing may connect to a tube or hose to allow use of the nozzle at a distance from the vapour producing device.

The invention allows for the nozzle to be changeable according to the vapour discharge that are required. A set may be provided with various different nozzles or aperture plates so that the vapour output can be varied. Thus, various different nozzles may be used on a single vapour-producing device to vary the density of the vapour produced and/or to create different sized and different numbers of vapour filled bubbles. Alternatively, a single nozzle may be used that allows for various bubble numbers and sizes to be created, preferably, using interchangeable face plates.

The invention extends to a vapour dispensing device comprising a nozzle as described herein. To operate the device the nozzle can be dipped into bubble liquid and then the vapour dispensed from the device to create a vapour-filled bubble.

The vapour dispensing device may comprise a first vapour source and a second vapour source, and at least one of the plurality of apertures in the nozzle is provided with vapour from the first source and at least one other of the plurality of apertures in the nozzle is provided with vapour from the second source. In such an arrangement, a first source of vapour and a second source of vapour are arranged within the dispensing device, and each is provided with an outlet to one or more of the apertures in the nozzle. Within the device a flow of air, or other gas, can be arranged upstream of the respective vapour outlets and the nozzle so that the vapour is pushed through the nozzle and into a bubble that can be formed therefrom. The air flow can be created by a fan element, compressed gas or another source, and it may employ a Venturi flow to draw the vapour into the gas stream, particularly where the cross-section through the face is larger than the cross-section through the neck.

The invention extends to a beverage or a food product having a plurality of vapour-filled bubbles thereupon. Using the nozzle of the present invention, along with a vapour dispensing device, a beverage can be garnished with vapour-filled bubbles. This can be particularly attractive to customers in bars and restaurants. Preferably, there are more than five vapour-filled bubbles and, advantageously, more than ten vapour-filled bubbles. Hitherto, such a garnish has not been possible as nozzles dispense a large single bubble; however, using the present invention, a plurality of vapour-filled bubbles, because the smaller bubbles can fit on top of the beverage.

It will be appreciated that the invention may extend to a method of garnishing a beverage or food product, comprising the steps of:
providing a vapour dispensing device, preferably in the form of a “vapour gun”;
connecting a nozzle to the vapour gun, the nozzle being as described herein; and
operating the vapour gun to apply a plurality of vapour-filled bubbles to the beverage or food product.

### BRIEF DESCRIPTION OF THE DRAWINGS

An embodiment of the invention will now be described, by way of example only, and with reference to the accompanying drawings, in which:

FIG. 1 is a diagram showing an exploded view of a nozzle in accordance with the present invention;

FIG. 2 is a diagram showing a top view of the nozzle of FIG. 1 in an assembled state;

FIG. 3 is a diagram showing a front view of the nozzle of FIG. 2;

FIG. 4 is a diagram showing a rear view of the nozzle of FIG. 3;

FIG. 5 is a diagram showing the nozzle of FIG. 2 connected to a housing;

FIG. 6 is a view of a beverage garnished with bubbles from the nozzle of the present invention.

### DETAILED DESCRIPTION OF EXEMPLARY EMBODIMENTS

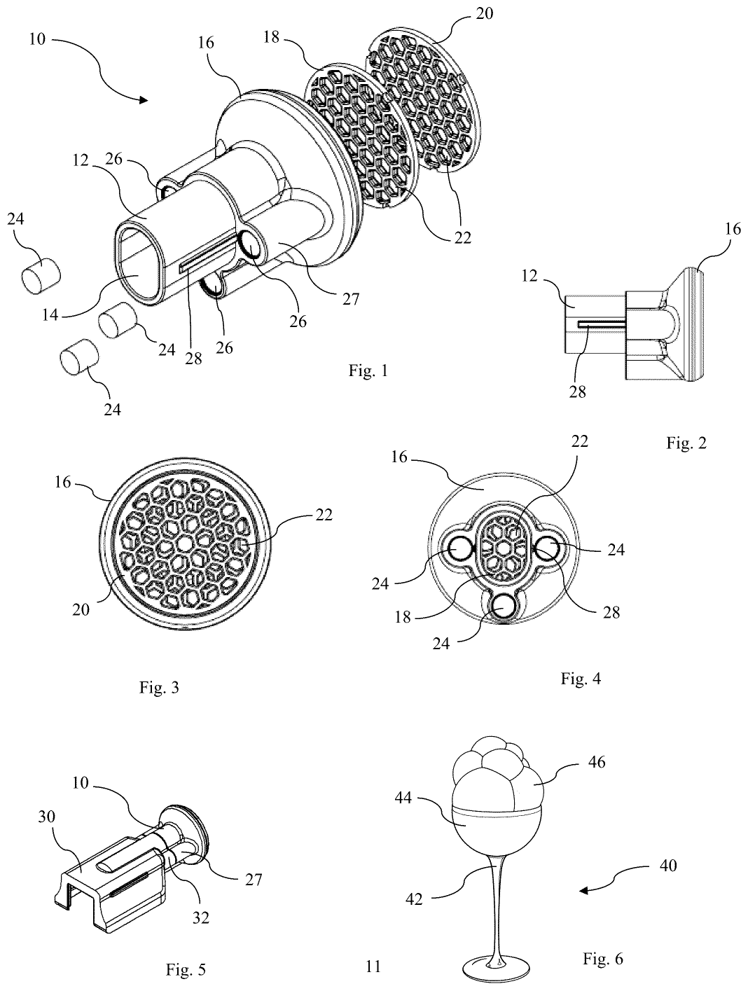

FIGS. 1 to 5 show a nozzle 10 having a neck 12 that has an inlet 14, the neck 12 having a bore therethrough. At the end of the neck 12 that is distal to the inlet 14 is a front face section 16, which has a larger radius and cross-sectional area than that of the neck 12. The front face section 16 is provided with a first face plate 18 and a second face plate 20 that are received into the front face section 16. First face plate 18 and second face plate 20 are each provided with a plurality of hexagonal apertures 22 therein. Thus, inlet 14 of the neck 12 is in fluid communication with the aperture 22 in the second face plate 22.

The first plate 18 and the second face plate 20 may be held within the front face section 16 by way of a push-fit mechanism. An alternative arrangement may be employed to hold the first face plate 18 and the second face plate 20 in the front face section 16, for example, screws passing through the face plates 18 and 20 and extending into the front face section 16, or screws or pins passing radially into the front face section 16 to hold the plates 18 and 20 securely. It will be appreciated that other mechanisms may be applicable, for example, a threaded arrangement or a bayonet fitting, which may be biased.

The first face plate 18 and the second face plate 20 may be arranged coaxial with one another; however, they may be rotationally offset. It will be appreciated that the first face plate 18 and the second face plate 20 can be rotationally aligned to provide a different bubble pattern.

On the rear of the front face section 16 is a connection section, which extends part way along the neck 12. The connection section comprises three magnets 24 that are housed within respective recesses 26 formed within lobes 27 on the rear of the front face section 16. The recesses 26 are arranged circumferentially around the neck 12 at 90 degrees, 180 degrees and 270 degrees, although the exact position may vary depending upon the device to which the nozzle 10 is to be connected. More or fewer magnets 24 may be applied in some arrangements.

The neck 12 is provided with protruding guide sections 28 on the periphery of the section that extends towards the inlet 12 from the front face section 16. The neck 12 and the guide sections 28 can be received within a vapour producing device to ensure that the nozzle 10 is correctly aligned in the device.

FIG. 5 shows one example of a housing element 30 that may be part of a vapour dispensing device, to which a nozzle 10 can be connected. The housing element 30 has lobes 32 in which magnets are held that, in combination with the magnets 24 housed within the lobes 27 of the nozzle 10, allow for quick, secure and easy attachment of the nozzle 10 to a vapour dispensing device. As can be seen, the neck 12 of the nozzle 10 is received into the housing element 30 to provide a secure fastening.

In use, the nozzle is connected to a device that can produce at least one source of vapour and that will drive the vapour towards the inlet 12 of the nozzle 10. The nozzle 10 can be provided with bubble mixture over the front of the front face section, which may be from dipping the front face section 16 into a bubble mixture, thereby creating a film of bubble mixture on the front of the nozzle. The vapour is then driven through the neck 12 towards the film of bubble mixture. The flow of air (or other gas) through the nozzle 10 forces the vapour through the plurality of apertures 22 in the first face plate 18 and the second face plate 20 and this expands the bubble mixture to create a plurality of bubbles that are filled with vapour. The bubbles that form can then be detached from the nozzle 10 onto a receptacle, onto a beverage or food item, or into the air.

FIG. 6 shows a garnished beverage 40 that comprises a glass 42, a liquid 44, which may be a cocktail or other liquid, and bubbles 46. The bubbles 46 are vapour-filled bubbles that are made using the nozzle of the present invention. The beverage 40 is prepared by filling the glass 42 with the liquid 44 to be consumed, after which vapour-filled bubbles 46 are dispensed from the nozzle 10 of a vapour dispensing device. The front face section 16 of the nozzle 10 can be dipped into a bubble mixture to produce bubbles 46 when the vapour is dispensed. In some arrangements, it may be advantageous to lubricate the rim of the glass 42, which may be done with water or bubble mixture to reduce the risk of the bubbles popping when coming into contact with the glass 42.

It will be appreciated that the bubble mixture may be omitted, in which case a vapour cloud can be produced. This may be used to fill a cloche, bottle or other items with a cloud of vapour. The use of a nozzle as described herein can assist with creating a denser vapour cloud than would be produced with traditional nozzles.

Once the first face plate and the second face plate are within the front face section, it may be possible to rotationally adjust one of the face plates relative to the other. This can allow adjustments to the density of the vapour produced and, when bubbles are created, the number of bubbles.

The device may be in the form of a vapour dispensing device nozzle, the nozzle comprising a plurality of apertures, wherein the nozzle comprises a neck portion and a face portion, with the neck portion having a smaller axial cross-sectional area than that of the face portion;
wherein the plurality of apertures is in the form of a layer of apertures positioned in the face portion of the nozzle; and
wherein a second layer of apertures is arranged adjacent the first layer of apertures and the apertures in the first layer are offset from the apertures in the second layer.

A hose or tube may be attached to the face of the nozzle to allow the vapour dispensed therefrom to be more readily placed inside a cloche or receptacle.

It will be appreciated that where bubble mixture is referenced, it is a food-safe, consumable mixture that does not contaminate any beverage or food product. Additionally, it is preferred that the bubble mixture is flavourless and/or odourless.

1. A vapour dispensing device nozzle, the nozzle comprising a plurality of apertures.

2. A nozzle according to claim 1, wherein the nozzle comprises a neck portion and a face portion, with the neck portion having a smaller axial cross-sectional area than that of the face portion.

3. A nozzle according to claim 2, wherein the plurality of apertures is in the form of a layer of apertures positioned in the face portion of the nozzle.

4. A nozzle according to claim 3, wherein a second layer of apertures is arranged adjacent the first layer of apertures and the apertures in the first layer are offset from the apertures in the second layer.

5. A nozzle according to claim 1, wherein the apertures are honeycomb in shape.

6. A nozzle according to claim 1, wherein the nozzle comprises rubber material.

7. A nozzle according to claim 1, wherein the nozzle comprises metallic material.

8. A nozzle according to claim 1, wherein the nozzle has the first part of a connection mechanism, so that the nozzle can be fitted to a vapour dispensing device.

9. A nozzle according to claim 8, wherein the connection mechanism comprises at least one magnetic portion to fit to a corresponding second part on a vapour dispensing device.

10. A nozzle according to claim 8, wherein the connection mechanism comprises a clip or part of a bayonet fitting, the clip or bayonet fitting adapted to fit to a corresponding second part on a vapour dispensing device.

11. A vapour dispensing device comprising a nozzle according to claim 1.

12. A vapour dispensing device according to claim 11, wherein the device has a first vapour source and a second vapour source and at least one of the plurality of apertures in the nozzle is provided with vapour from the first source and at least one other of the plurality of apertures in the nozzle is provided with vapour from the second source.

13. A beverage or food product garnished with a plurality of vapour-filled bubbles.
